(19) United States
(12) Patent Application Publication
(10) Pub. No.: US 2013/0262412 A1
(43) Pub. Date: Oct. 3, 2013

(54) Method and System For Database Transaction Log Compression On SQL Server

(71) Applicants: Brett Derek Hawton, Alamo, CA (US); Marius F. du Toit, Ocoee, FL (US); Mark David Wright, Austin, TX (US)

(72) Inventors: Brett Derek Hawton, Alamo, CA (US); Marius F. du Toit, Ocoee, FL (US); Mark David Wright, Austin, TX (US)

(21) Appl. No.: 13/831,175

(22) Filed: Mar. 14, 2013

Related U.S. Application Data
(60) Provisional application No. 61/616,744, filed on Mar. 28, 2012.

(51) Int. Cl. G06F 17/30

(52) U.S. Cl. CPC G06F 17/30153
USPC 707/693

(57) ABSTRACT

The present invention provides a method and system for providing database transaction log compression, where the transaction log data that is written to the transaction log file is compressed independently from the database data. In accordance with the present invention, the method and system provide for obtaining data to be written to the database transaction log file, compressing the data to be written to the database transaction log file and writing the compressed transaction log data to the database transaction log file.

### CROSS-REFERENCE TO RELATED APPLICATION

This application claims the benefit of U.S. provisional patent application No. 61/616,744, filed Mar. 28, 2012. U.S. provisional patent application No. 61/616,744 is specifically incorporated by reference herein.

### FIELD OF THE INVENTION

The present invention generally relates to computer database management software and the method it uses to write the transaction log of the database management system. Specifically, it relates to the compression of the database transaction log data to be written to the transaction log and the writing of the compressed database transaction log data to the database transaction log file.

### BACKGROUND OF THE INVENTION

The Microsoft SQL Server is a relational database management system (RDBMS) and includes the Structured Query Language (SQL), a standard language for obtaining and modifying information stored on a database. The Microsoft SQL Server transaction log is a file on the disk IO subsystem to which all changes made to the database (usually in the form of transactions) are recorded. The database transaction log (also referred to herein as the transaction log) generally has two primary uses. One use of the transaction log occurs when a discreet transaction makes a great many changes to the database. If a transaction involves extensive changes to the database data then the memory buffer holding the unwritten portion of the transaction log may become full. When the memory buffer becomes full the IO subsystem will begin to write transaction records to the transaction log file on disk. However, at some point it may be decided that the transaction as a whole should be “rolled back” and the changes undone. In this case the transaction records already written to disk need to be re-read and the changes contained therein need to be un-done on the database data in order to undo the changes made. The second primary use of the transaction log occurs when for some reason the database data files themselves have become corrupted or unavailable in some way. In this case, the database needs to be recreated back to the point of failure. Recreating the database data is accomplished using the last known good backup of the database and applying the committed transactions contained in the transaction log to the good database data.

In essence, the SQL Server transaction log contains the sequential list of changes made to the database over time for the purposes of recovery, should that be required. In order to ensure recoverability, SQL Server enforces a rule such that, when an application requests that a transaction containing database changes be committed, the SQL Server must pass the transaction log changes to the operating system and request the operating system to commit these changes to disk and report back when completed. The operating system in turn requests the disk IO subsystem to write the transaction log records to disk. Once the disk 10 subsystem reports to the operating system that the write was successful, the operating system reports the same to SQL Server. The SQL Server will then report completion of the “commit transaction” to the application, which can then continue on with other work.

It is important to note that the transaction log is a verbose record of events. For example, consider a database table containing the following 4 columns: Person (character field); Action_Taken (character field); Person's_Age_In_Hours (integer field); and Number_of_Actions_Taken (integer field). Next insert the following values into a row of the table: Into the Person column insert “picky person”; Into the Action_Taken column insert “A picky person used a pick-axe to pick up pickles to pickle in a pickle jar.”; Into the Person's_Age_In_Hours column insert 411162; Into the Number_of_Actions_Taken column insert 1119. The conventional SQL Server database would write the transaction log data as follows: “picky person”; “A picky person used a pick-axe to pick up pickles to pickle in a pickle jar”;411162; 1119. Thus, the transaction log is a copy of what was inserted into the columns of the table. The reason for the gaps between the characters in the character fields is that the conventional SQL Server supports double-byte character sets in order to handle languages such as Korean where two bytes are needed in order to represent their full alphabet. Even though Korean is not being used here it still retains two bytes per character.

In an upcoming version of Microsoft Server 2008 R2, the data storage of unicode (double byte) character strings (both on the database itself and also on what the transaction log will write out to recover the data) will be reduced when using languages that do not require two bytes per character, which is most western languages. For languages that do not require two bytes, only a single character will be stored in the database and hence the transaction log as well. This will be accomplished by taking out each alternate “space character” in a string written in a western language. This change to SQL Server, when released, will therefore save the data in the database as well as the transaction log as “picky person”, “A picky person used a pick-axe to pick up pickles to pickle in a pickle jar”, 411162 and 1119. The unused alternate bytes in both the database and the transaction log are removed. Consequently, the transaction logs contents are not different or more compressed than the contents of the database itself.

### SUMMARY OF THE INVENTION

The present invention addresses the above needs by providing a method and system for compressing the data to be written to the transaction log optimally and differently from the database contents.

### BRIEF DESCRIPTION OF THE DRAWINGS

The foregoing aspects and many attendant advantages of this invention will become more readily appreciated by reference to the following detailed description, when taken in conjunction with the accompanying drawings, wherein:

FIG. 1 is a block diagram of a representative computer system environment in which the invention may be implemented; and

FIG. 2 is a flow diagram illustrating a routine for compressing the data stream being written to the database transaction log.

### DETAILED DESCRIPTION OF THE PREFERRED EMBODIMENT

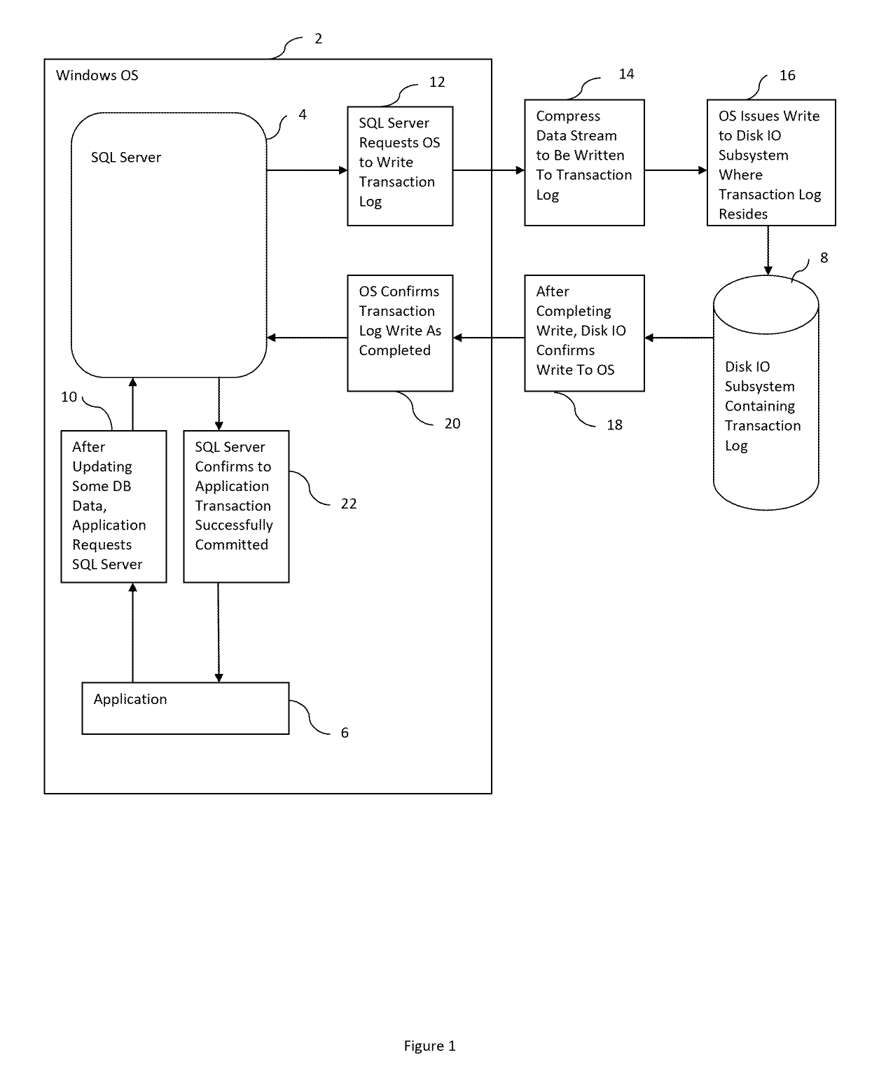

FIG. 1 illustrates an example of a suitable computing system environment in which the invention may be implemented. The computing system environment is only one example of a suitable computing environment and is not intended to suggest any limitation as to the scope of use or functionality of the invention. Neither should the computing environment be interpreted as having any dependency requirement relating to any one or combination of components illustrated in the exemplary operating environment.

The invention may be described in the general context of computer-executable instructions, such as program modules, being executed by a computer. Generally, program modules include routines, programs, objects, components, data structures, etc. that perform a particular task or implement particular abstract data types. The invention may also be practiced in distributed computing environments where tasks are performed by remote processing devices that are linked through a communications network. In a distributed computing environment, program modules may be located in both local and remote computer storage media, including memory storage devices.

With reference to FIG. 1, an exemplary system for implementing the invention includes a general-purpose computing device in the form of a server computer 2. Components of a server computer 2 include, but are not limited to, a central processing unit (CPU), a system memory. The system memory includes computer storage media in the form of volatile and/or nonvolatile memory, such as read-only memory and random-access memory. The server computer 2 may operate in a network environment using logical connections to one or more remote computers. The remote computer may be a personal computer, a server, a router, a network PC, a peer device or other common network node, and typically includes many or all of the elements described above relative to server computer 2. The logical connections include a local area network (LAN) and wide area network (WAN), but also include other networks. Such network environments are commonplace in office, enterprise-wide computer networks, intranets, and the Internet.

The server computer includes I/O device drivers, which are installed software routines for enabling the computer to transmit and receive data to and from input/output devices depending on the current situation. The server computer 2 is connected to computer data storage device 8. Computer data storage device 8 may store a database, which are files composed of records each containing fields together with a set of operations for search, sorting, recombining, and other functions. The database management system is a software interface between the database and the user. A database management system handles user requests for database actions and allows for control of security and data integrity requirements. The database management system is sometimes referred to by the acronym DBMS and is also sometimes called the database manager. A database server is a network node or station dedicated to storing and providing access to a shared database. The database machine is a peripheral that executes data set tasks, thereby relieving the main computer form performing them. A database machine is also referred to as a database server and performs only database tasks.

A database structure is a general description of the format of records in a database, including the number of fields, specifications regarding the typed of data that can be entered in each field, and the fields names used. Data storage device 8 may store a special type of database called relational database. A relational database is a database or database management system that stores information in tables—rows and columns of data—and conducts searches by using data in specified columns of one table to find additional data in another table. In a relational database the rows of a table represent records (collections of information about separate items) and the columns represent fields (particular attributes of a record). In conducting searches, a relational database matches information from a field in one table with information in a corresponding field of another to produce a third table that combines requested data from both tables. The Microsoft SQL Server is an example of a relational database management system (RDBMS) and includes the Structured Query Language (SQL), the standard language for obtaining and modifying information stored on a database.

The server computer 2 uses logical connections to one or more data storage devices to transmit information to the data storage devices. The information transmitted includes DBMS data and DBMS transaction log record to be stored in the database on the data storage device 8. The logical connections include a local area network (LAN) and wide area network (WAN), but also include other networks. Such network environments are commonplace in office, enterprise-wide computer networks, intranets, and the Internet.

The server computer 2 includes an operating system, which is software that controls the allocation and usage of hardware resources such as memory, central processing unit (CPU), disk space, and peripheral devices. The operating system is the foundation software on which applications depend. Popular operating systems include Windows 7, Windows Vista, Windows XP, Linux, Mac OS X, and Unix.

The server computer includes an application 6 that accesses and updates information stored in the database via the SQL Server 4. An action to be taken on the database data is called a transaction. When an application performs an action on database data and wants to save any changes made by the action, the application will issue a request to the SQL Server to “commit” the transaction. If application 6 wants to save any updates or changes it has made to the database data, then application 6 will issue a request 10 to the SQL Server 4 to “commit” the transaction. In response to receiving the application request to commit the transaction, the SQL Server 4 issues a request 12 to the Operating System to write the transaction data to the transaction log. The present invention obtains the transaction data stream to be written to the transaction log and compresses 14 the transaction log data that is to be written to the transaction log. Those of ordinary skill in the relevant art will appreciate the variety of methods available for obtaining the data stream about to be written to the transaction log. In accordance with the preferred embodiment, the present invention obtains the data stream (the terms data and data stream are used interchangeably herein) about to be written to the transaction log at the Windows Operating System level. The present invention is not intended to be limited in scope to any particular implementation for obtaining the data stream about to be written to the transaction log and any manner readily apparent to those of ordinary skill in the relevant art is intended to be included within the scope of the presently claimed invention. FIG. 1 is illustrative of the preferred embodiment of the present invention and is not intended to limit the scope or functionality of the present invention.

After compressing 14 the transaction log data, the Operating System will send a request 16 to the Disk IO subsystem to write the compressed transaction log data to the transaction log file on the data storage device 8 where the transaction log file resides. When the Disk IO subsystem has successfully completed the write it will send a message 18 to the Operating System confirming completion of the requested transaction log write. The Operating System will then send confirmation 20 to the SQL Server that the write to the transaction log was successfully completed. Finally, the SQL Server 4 will then send confirmation 22 to the application 6 that the transaction was successfully committed.

As described above, the present invention truly compresses the entire transaction log record (i.e. all columns). In the preferred embodiment the entire transaction log record is compressed utilizing either a commercial or bespoke (custom-designed) compressor. It should be noted that the present invention is not limited in scope to any particular compressor, compression software or compression algorithm and any true data compression available to those of ordinary skill in the relevant art is intended to fall within the scope of the present invention. Thus, the data being written to the database remains in its current form as described by Microsoft SQL Server, but the present invention provides for compressing the data going to the transaction log optimally and differently from the database contents.

To illustrate the difference between the conventional writing of the database transaction log and the present invention consider the aforementioned example, where the transaction log record has four columns containing the following values: “picky person”; “A picky p erson used a pick-axe to pick up pickles to pickle in a pickl e jar”; 411162; 1119. A true compressor will compress the entire string of data which is to be written to the transaction log as one. In the above example, the letters “pick” appear 7 times across 2 columns and hence a compressor would detect this correlation and combine all instances of “pick”, completely rearranging the entire sequence of both columns if that made sense. It would also detect that “111” appears twice no matter if that was in 2 different columns and again would combine both instances. This is true compression applied across all columns no matter what language is used in the data string and rearranging the entire sequence if necessary.

In this way, the present invention compresses the transaction log independently of how the data is to be stored in the database itself. In contrast, at most a conventional Microsoft SQL Server may remove alternate Unicode empty “spaces” in the data of the database itself and the transaction log would simply mirror these changes. Thus, the conventional Microsoft transaction log simply mirrors the structure of the database whereas only the present invention actually applies true data compression to the entire transaction log data independently of how the data is stored in the database.

The present invention provides significant advantages by truly compressing the data stream to be written to the transaction log. By writing the completely compressed data stream, less data is written and the less written the faster IO subsystem will respond that the write has completed and the transaction can be considered “committed”. Only the present invention provides a method for writing database transactions where the transaction log is compressed more than the data in the database, which enhances application and database performance by completing transactions substantially faster than would occur with conventional transaction log writing.

In hindsight, due to the significant performance gains described above, it may seem surprising that conventional database management systems fail to perform true compression of the transaction log data. Conventional relational database management systems do not provide true compression of transaction log data to be written and consequently miss the opportunity for significantly enhanced database performance. The closest conventional database management systems appear to come to the concept of true compression of the transaction log data to be written can be seen with the Microsoft SQL Server 2008. The Microsoft SQL Server 2008 supports database mirroring, which is the process of keeping the data on two or more servers synchronized. The synchronization of two servers across a network is achieved by harvesting the transactions destined to be written to the transaction log on the “source” (or principle) server and then first compressing the data and then streaming it across the network to the other “target” mirror server. The reason for the compression of the data stream in this case is that networks are often slow and hence data compressing really was necessary for transmission purposes. Notice that, even though the SQL Server team compresses the transaction data streaming across to the mirror server, the data in transaction log written to the IO subsystem of the source server (and indeed the target mirror server too) remains uncompressed or at least compressed only because the data in the database may have been compressed but nothing additionally. This shows that it was clearly not apparent to Microsoft that compression of the data destined to be written to the transaction log of the local “source” machine would be beneficial.

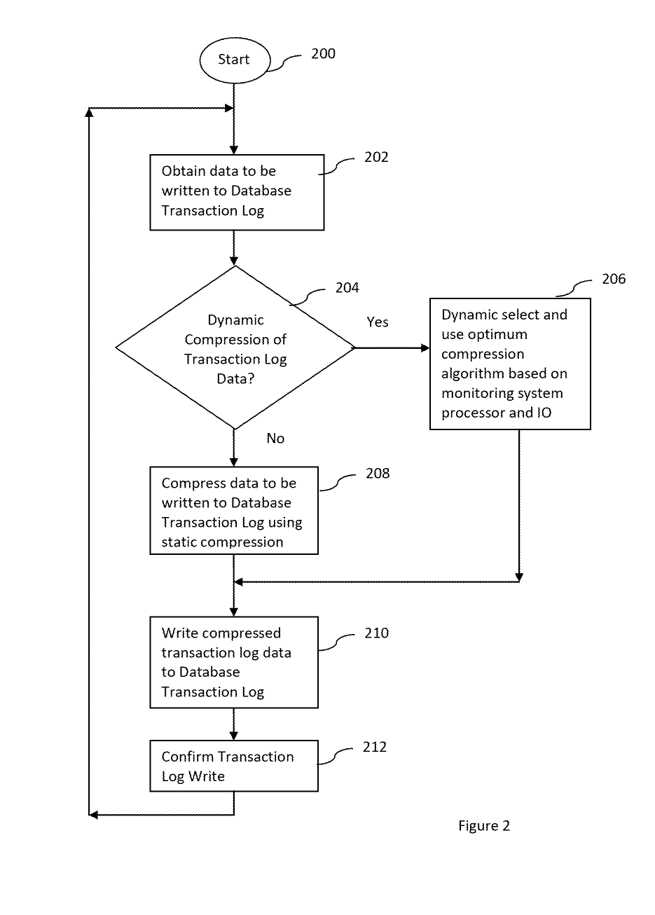

Turning now to FIG. 2, which generally described is a flow diagram illustrating a routine 200 for providing compression of transaction log data to be written to the database transaction log file. With reference to FIG. 2, at block 202, the transaction log data to be written to the transaction log is obtained. Proceeding to decision block 204, a test is performed to determine if a dynamic form of compression of the transaction log data is to be used. If at decision block 204 it was determined that dynamic compression is to be performed then routine 200 proceeds to block 206 and a dynamically selected compression algorithm for optimal compression of the transaction log data is performed. After dynamic compression of the transaction log data is performed at block 206 routine 200 proceeds to block 210. However if at decision block 204 it was determined that compression is to be of a static form then routine 200 proceeds to block 208. At block 208 the transaction log data is compressed using a static compression algorithm. After performing the static compression at block 208, routine 200 proceeds to block 210. Next at block 210, the compressed transaction log data is written to the transaction log. After the write completes, confirmation of the transaction log write is issued at block 212. The routine 200 returns to block 202 and repeats the aforementioned process.

As discussed above with reference to FIG. 2, and in accordance with the preferred embodiment of the present invention, the compression of the data stream to be written to the transaction log can take one of the two aforementioned forms, static and dynamic. The first form is the static compressor, which is a single compressor using a single set of compression algorithms. The static compressor would therefore compress every data stream in the same way and would take no notice of the fact that it may be taking far longer to compress the data stream than the IO subsystem of the server would have taken to write out the uncompressed stream. This would likely happen when a server configuration contained relatively slow processors (or a heavy processor load) with a fast IO subsystem which was able to write the transaction log data stream very quickly.

The second form of compression uses a dynamic compressor to optimally compress the transaction log data to be written to the database transaction log. The dynamic compressor monitors the speed of compression of the data stream destined to be written to the transaction log and also monitors the speed that the IO subsystem wrote transaction log data. Consider the scenario where the dynamic compressor monitors the system to detect that it is running on a server with very fast processors (or lightly loaded processors) and the 10 subsystem is very slow. In this scenario, the dynamic compressor would increase compression of the data stream by selecting a compressor that compressed the data stream more at the expense of additional processor cycles. Here, the higher compression would be performed because the processor(s) were fast enough to perform this work and this would reduce the net compressed size of the data stream to be written by the slow IO subsystem and hence the elapsed time of the whole operation (compression and writing) would be further reduced.

Alternatively, consider the scenario where monitoring detects that the server has very slow processors (or very busy processors) and a fast IO subsystem. In this scenario, a very fast and light compressor could be selected and would not compress the data stream as much since here the IO subsystem could write the larger compressed data stream very swiftly. In this way an algorithm can be used to determine the best balance between compression speed and IO write speed, such that the shortest elapsed time (including both compression and IO write time) is constantly found. This algorithm could use a Proportional, Integral, Derivative type control mechanism (also referred to herein as a PID). A PID controller is a generic control loop feedback mechanism widely used and well known to those of ordinary skill in the art. A PID controller calculates an “error” value as the difference between a measured process variable and a desired setpoint. The controller attempts to minimize the error by adjusting the process control inputs. The PID controller calculation (also referred to herein as algorithm) involves three separate constant parameters, and is sometimes called three-term control: The proportional, the integral and derivative values. Heuristically, these values can e interpreted in terms of time: P depends on the present error, I on the accumulation of past errors, and D is a prediction of future errors, based on current rate of change. The weighted sum of these three actions is use to adjust the process via a control element. Alternatively, the algorithm could simply take the elapsed times of the compressor and the IO write time and directly balance the two to achieve the same effect of finding the shortest overall elapsed time to both compress and write the data stream.

In summary, only the present invention provides a method and system such that the data stream destined to be written to the database transaction log would always be truly compressed independently of the data residing in the database. In contrast, conventional SQL Server transaction logs contain data in the same format as the database. Unlike the present invention, the conventional SQL Server provides that if data in the database is compressed (or Unicode “empty” characters removed) then the transaction log reflects this same format. Conversely, with a conventional SQL Server, if the data in the database isn't compressed then neither is the data in transaction log written out to the IO subsystem. Thus the present invention provides a method and system for providing database transaction log compression and provides benefits of significantly enhanced performance whereby application and database transactions complete substantially faster than in the prior art where transaction log data is not compressed differently from the data stored in the database.

The present invention further provides additional features whereby the transaction log data compression is accomplished utilizing either a static compression ratio/algorithm or a dynamic range of compressors/algorithms to fully optimize the process on both servers having fast processors and slow IO subsystems as well as servers having slow (or busy) processors and fast IO subsystems. The benefits of compressing transaction log data and writing compressed transaction log data to the transaction log file are significant in both the amount of storage used and in the amount of time required to write the data. Only the present invention provides these significant benefits, which are not available in the prior art.

The embodiments of the invention in which an exclusive property or privilege is claimed are defined as follows:

1. A method for providing database transaction log compression, where the transaction log data that is written to the transaction log file is compressed independently from the database data, the method comprising:
obtaining data to be written to the database transaction log file;
compressing said data to be written to said database transaction log file; and
writing said compressed transaction log data to said database transaction log file.

2. The method of claim 1, wherein a single static compression algorithm is used to compress said transaction log data.

3. The method of claim 1, further providing use of one of a range of compression algorithms to compress said transaction log data.

4. The method of claim 3, further providing:
monitoring the speed and of at least system processor of the server computer on which the database management system resides;
monitoring the speed of IO subsystem used for writing said database transaction log file;
determining the best of said range of compression algorithms; and
dynamically selecting of one of said range of compression algorithms to be used based on a determination of the optimum speed of compression desired based on said monitoring information.

5. The method of claim 4, wherein monitoring the speed of the processor and the 10 subsystem includes monitoring the work load of the processor and IO subsystem.

6. The method of claim 3, wherein the dynamic compression uses a PID type algorithm.

7. A computer readable medium containing computer executable instructions for performing the method of claim 1.

8. A server computer system for providing database transaction log compression, the system comprising:
A server computer having an operating system;
An SQL server database management system;
A compression algorithm for compressing transaction log data; and
A disk IO subsystem for writing said compressed transaction log data and for storing the compressed database transaction log file.

9. The system of claim 8, further comprising a single static compression algorithm is used to compress said transaction log data.

10. The system of claim 8, further comprising a range of compression algorithms to compress said transaction log data.

11. The system of claim 10, further providing a computer software component for providing:
monitoring the speed and of at least system processor of the server computer on which the database management system resides;
monitoring the speed of IO subsystem used for writing said database transaction log file;
determining the best of said range of compression algorithms; and
dynamically selecting of one of said range of compression algorithms to be used based on a determination of the optimum speed of compression desired based on said monitoring information.
